(19) United States
(12) Patent Application Publication
(10) Pub. No.: US 2026/0196149 A1
(43) Pub. Date: Jul. 9, 2026

(54) COLOR VISION IMPROVEMENTS FOR COLOR VISION DEFICIENCY

(71) Applicant: QUALCOMM Incorporated, San Diego, CA (US)

(72) Inventors: Abhijeet DEY, Bengaluru (IN); Milan JAUHARI, Lucknow (IN); K Varun SUNDARR, Tiruchirappalli (IN); Joby ABRAHAM, Bangalore (IN)

(21) Appl. No.: 19/014,131

(22) Filed: Jan. 8, 2025

(51) Int. Cl. G09G 3/00

(52) U.S. Cl. CPC G09G 3/001; G09G 2320/0242; G09G 2340/06

(57) ABSTRACT

Systems and techniques are described herein for color compensation. For instance, a process can include displaying a visual representation of a color spectrum; receiving an indication of boundaries of a sector within a color band, wherein the color band represents an extent of a color for normal vision; mapping a first color outside of the boundaries of the sector and within the color band to a second color within the sector; and rendering an image using the second color based on the mapping.

### FIELD

The present disclosure generally relates to displaying colors. For example, aspects of the present disclosure are related to systems and techniques for color vision improvements for color vision deficiency, for example, when viewing colors on a display screen.

### BACKGROUND

An extended reality (XR) (e.g., virtual reality, augmented reality, mixed reality) system can provide a user with a virtual experience by immersing the user in a completely virtual environment (made up of virtual content) and/or can provide the user with an augmented or mixed reality experience by combining a real-world or physical environment with a virtual environment.

One example use case for XR content that provides virtual, augmented, or mixed reality to users is to present a user with a “metaverse” experience. The metaverse is essentially a virtual universe that includes one or more three-dimensional (3D) virtual worlds. For example, a metaverse virtual environment may allow a user to virtually interact with other users (e.g., in a social setting, in a virtual meeting, etc.), to virtually shop for goods, services, property, or other item, to play computer games, and/or to experience other services.

Generally, while XR content may have audio and haptic elements, a large part of XR content may be relatively visually focused. Techniques to improve the visual experience as much as possible for people with color vision deficiencies, or color blindness, may therefore be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for herein for color compensation. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, apparatuses, methods and computer-readable media for image processing are provided. In one illustrative example, an apparatus for color compensation is provided. The apparatus includes a memory and at least one processor coupled to the at least one memory. The at least one processor is configured to: display a visual representation of a color spectrum; receive an indication of boundaries of a sector within a color band, wherein the color band represents an extent of a color for normal vision; map a first color outside of the boundaries of the sector and within the color band to a second color within the sector; and render an image using the second color based on the mapping.

As another example, a method for color compensation is provided. The method includes: displaying a visual representation of a color spectrum; receiving an indication of boundaries of a sector within a color band, wherein the color band represents an extent of a color for normal vision; mapping a first color outside of the boundaries of the sector and within the color band to a second color within the sector; and rendering an image using the second color based on the mapping.

In another example, a non-transitory computer-readable medium having stored thereon instructions is provided. The instructions, when executed by at least one processor, cause the at least one processor to: display a visual representation of a color spectrum; receive an indication of boundaries of a sector within a color band, wherein the color band represents an extent of a color for normal vision; map a first color outside of the boundaries of the sector and within the color band to a second color within the sector; and render an image using the second color based on the mapping.

As another example, an apparatus for color compensation is provided. The apparatus includes: means for displaying a visual representation of a color spectrum; means for receiving an indication of boundaries of a sector within a color band, wherein the color band represents an extent of a color for normal vision; means for mapping a first color outside of the boundaries of the sector and within the color band to a second color within the sector; and means for rendering an image using the second color based on the mapping.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) include at least one camera for capturing one or more images or video frames. For example, the apparatus(es) can include a camera (e.g., an RGB camera) or multiple cameras for capturing one or more images and/or one or more videos including video frames. In some aspects, the apparatus(es) can include a display for displaying one or more images, videos, notifications, or other displayable data. In some aspects, the apparatus(es) can include a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Illustrative embodiments of the present application are described in detail below with reference to the following figures:

FIG. 1 illustrates an example implementation of a system-on-a-chip (SOC), in accordance with some examples;

FIG. 2 illustrates classes of color vision deficiency (CVD);

FIG. 3 illustrates calibration for a technique for color vision improvements for anomaly CVD, in accordance with aspects of the present disclosure;

FIG. 4A is a color wheel illustrating color mapping, in accordance with aspects of the present disclosure;

FIG. 4B is a green sector of a color wheel illustrating color mapping, in accordance with aspects of the present disclosure;

FIG. 5 is a flow diagram illustrating a process for color vision improvements for anomaly CVD, in accordance with aspects of the present disclosure;

FIG. 6 is a block diagram illustrating a system for color vision improvements for CVD, in accordance with aspects of the present disclosure;

FIG. 7 is a flow diagram illustrating a process for color compensation, in accordance with aspects of the present disclosure;

FIG. 8 illustrates an example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

Color vision deficiency (CVD), also known as color blindness is a condition that affects an estimated 300 million people in the world. People with CVD may perceive colors differently as compared to those without CVD and people with CVD may have a compromised ability to recognize and/or differentiate different colors. For example, human color vision is based on three classes of photoreceptors, known as cones. Each class of cones is sensitive to photons of different classes of wavelengths, such as short wavelengths (e.g., blue light), medium wavelengths (e.g., green light), and long wavelength (e.g., red light).

To help people with CVD, conventional techniques may adjust colors that may be wrongly perceived as identical (e.g., confusion colors, such as red and green for a person with protanopia) by a person with CVD. These techniques typically are focused on addressing anopia (where a person completely lacks one of the three classes of cones) but may also be applied for persons with anomaly (where a person has a reduced ability to perceive a color corresponding to one of the three classes of cones) as well. Such techniques may focus on creating a high-contrast style image to help a person distinguish between the colors. However, by limiting colors based on a complete inability to perceive certain colors, such techniques may over-reduce the vision spectrum for people with anomaly CVD. Thus, a technique for addressing anomaly CVD differently from anopia 202 may be useful.

Systems, apparatuses, electronic devices, methods (also referred to as processes), and computer-readable media (collectively referred to herein as “systems and techniques”) are described for color vision improvements for anomaly CVD. For example, a visual representation of a color spectrum may be displayed to a user of a device, such as a portable device, XR device, head-mounted device (HMD), etc. In some cases, the color vision improvements for CVD may be activated, for example, as a setting of the device. The visual representation of the color spectrum may be a color wheel or any other representation of the spectrum.

In some cases, the visual representation of the color spectrum may include adjustable (e.g., moveable) boundaries (e.g., boundary markers) for a sector, where the boundaries may be moved (e.g., by the user) to represent an extent of perception of the particular color by the user. For example, where the user has limited perception for green, they may move the boundaries to where they perceive are the maximum extents (e.g., boundaries) of what they can see as green. The area within the boundaries may be visible as green to the user and the area within the boundaries may be referred to as a sector. The boundary markers may be inside of (e.g., a subset of) a color band. The color band may represent an extent (e.g., area) of the color (e.g., green) for normal vision (e.g., as appears to a person with normal vision). The device may receive an indication of the boundaries of the sector from the user (e.g., the user may move the boundaries). In some cases, the user may be prompted to input a type of CVD they may have. Based on this indication of the type of CVD, an initial position of the boundaries on the visual representation of the color spectrum may be set.

Based on the boundaries for the sector, colors outside of the boundaries and within the color band may be mapped to colors inside of the sector. For example, a center marker between the boundaries of the sector may be determined and colors outside of the boundaries and within the color band may be mapped to colors along the center marker. In some cases, a radial distance between a color to be mapped and a center of the color wheel may be determined and the mapped color may be mapped to be the radial distance from the center of the color wheel to allow for intensity based color compensation/correction. Thus, an image that includes colors that a person with CVD may have difficulties with (e.g., a confusion color, such as a particular shade of green that the person with CVD does not see as green) may have those colors replaced with a mapped color that they can see (e.g., the particular shade of green may be replaced with a different shade of green color that the person with CVD can see).

Various aspects of the present disclosure will be described with respect to the figures.

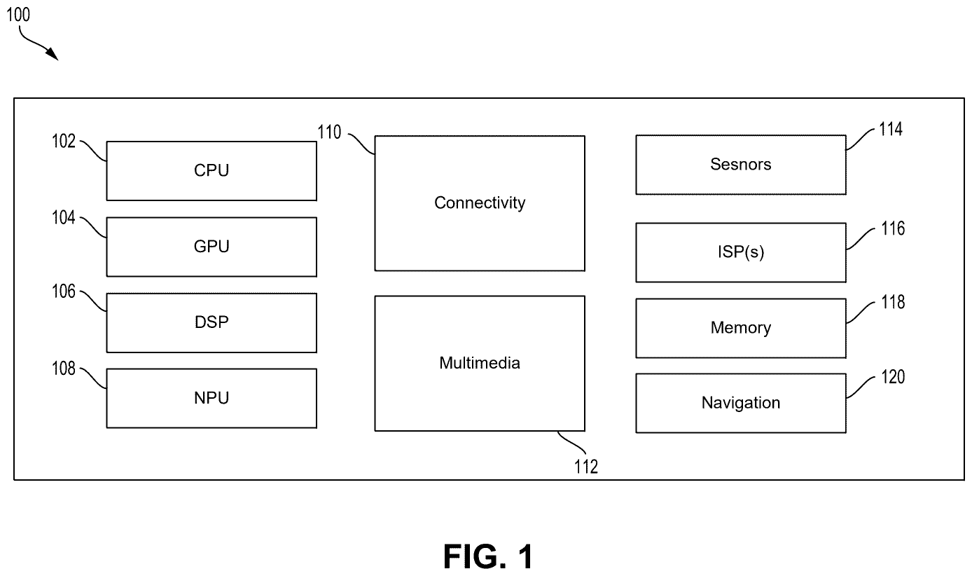

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

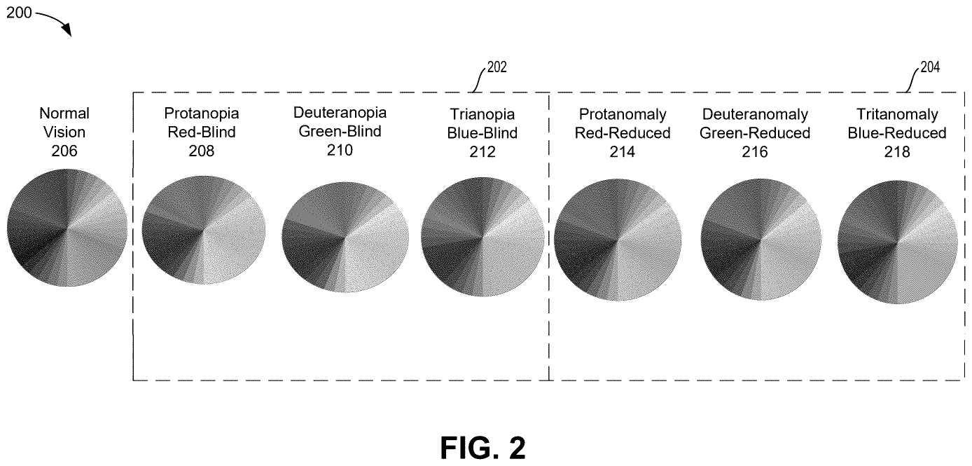

FIG. 2 illustrates classes of color vision deficiency (CVD) 200. As shown, CVD may be divided into two major types of CVD: anopia 202 and anomaly 204. A person with anopia 202 may completely lack one of the three classes of cones. A person with anomaly 204 may have a reduced ability to perceive a color corresponding to one of the three classes of cones. A third, rare, type of CVD is complete CVD or achromatopsia (not shown), which is marked by a complete inability to perceive colors. Achromatopsia is outside of the scope of this disclosure.

A person with normal vision 206 may have all three classes of cones and see a full spectrum of color. There may be three types of anopia 202, protanopia 208, deuteranopia 210, and trianopia 212. A person with protanopia 208 may lack cones for perceiving long wavelength (L) light (e.g., red light) and they may be unable to tell a difference between red and green at all. A person with deuteranopia 210 may lack cones for perceiving medium wavelengths (M) light (e.g., green light) and they may also be unable to distinguish between green and red. A person with trianopia 212 may lack cones for perceiving short wavelength(S) light (e.g., blue light) and then may be unable to distinguish blue and green.

There may be three types of anomaly 204, protanomaly 214, deuteranomaly 216, and tritanomaly 218. A person with protanomaly 214 may have fewer cones for perceiving L light (or have L cones that are not properly responsive to a full red spectrum, as compared to a person with normal vision) and certain shades of red may appear more green and/or less bright. A person with deuteranomaly 216 may have fewer cones for perceiving M light (or have M cones that are not properly responsive a full green spectrum, as compared to a person with normal vision) and certain shades of green may appear more red. Deuteranomaly 216 may be the most common type of CVD. A person with tritanomaly 218 may have fewer cones for perceiving S light (or have S cones that are not properly responsive a full blue spectrum, as compared to a person with normal vision) and they may be unable to tell a difference between blue and green and/or between yellow and red. In some cases, the colors that a person with anopia 202 or anomaly 204 have difficulties perceiving and the color that they may perceive instead may be referred to a confusion colors.

To help people with CVD, conventional techniques may adjust colors that may be wrongly perceived as identical (e.g., red and green for a person with protanopia 208) by a person with CVD. However, these techniques typically are focused on addressing anopia 202 and may also be applied for persons with anomaly 204 as well. However, such techniques may focus on creating a high-contrast style image to help a person distinguish between the confusion colors, but without consideration to preserving color accuracy of the original image. For example, a person with anomaly 204 is still capable of perceiving a certain range of confusion colors. By adjusting and limiting color spectrum to help those with anopia 202 CVD (e.g., for those with a complete inability to perceive certain colors), such conventional techniques may over-reduce the vision spectrum for people with anomaly 204 CVD. Moreover, it is estimated that more people have anomaly 204 as compared to anopia 202. Additionally, there may be no notion of user feedback for adapting the color adjustment for the person. Thus, a device wide solution for addressing anomaly 204 CVD differently from anopia 202 CVD may be useful.

In some cases, it may be useful to perform color adjustments for persons with anomaly CVD by calibrating (e.g., tailoring) the color correction amounts based on a severity of the anomaly CVD for a particular user and then perform an intensity based correction of confusion colors based on the calibrations so they are tailored to the particular user. This may allow color correction to be performed while still preserving colors in a way that is personalized to the particular user.

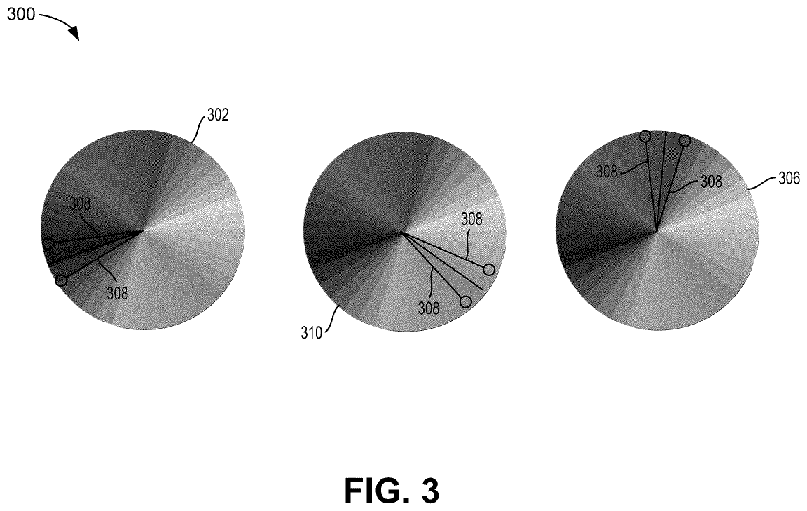

FIG. 3 illustrates calibration for a technique for color vision improvements 300 for anomaly CVD, in accordance with aspects of the present disclosure. In some cases, calibration may be used to help determine a type and severity of CVD a particular user has. Calibration may be performed based on a visual representation of color spectrum, such as color wheel 302, color wheel 304, and color wheel 306, or another visual representation of a color spectrum (e.g., color chart, rainbow color map, color spaces map, portion of a color wheel, etc.). The color wheel (e.g., color wheels 302-306) may include values indicating a maximum extent of the primary colors (e.g., red, green, and blue) for normal vision. For example, the boundaries (e.g., color values) of where red (e.g., where red becomes violet and orange), green (e.g., where green becomes yellow and teal), and blue (e.g., where blue becomes teal and purple) begin and end for people with normal vision may be known for the color wheel. An area within the boundaries at the maximum extent of a primary color for a person with normal vision may be a color band.

In some cases, a prompt may be displayed asking the user what type of CVD they may have (e.g., anopia, anomaly, deuteranomaly, deuteranopia, etc.). The user may input what type of CVD they have, for example, based on a previously taken Ishihara test. An Ishihara test may be a test for color vision. The user input may be used to determine roughly where to place markers on the color wheel, such as color wheel 302. For example, if a user indicates that they have tritanomaly, then boundary markers 308 may be placed on the color wheel 302 corresponding to where blue is. Color wheel 304 indicates where boundary markers 308 may be placed for deuteranomaly, and color wheel 306 indicates where boundary markers 308 may be placed for protanomaly.

In some cases, the boundary markers 308 may be placed at the boundaries of a primary color corresponding to the type of CVD indicated. In other cases, the boundary markers 308 may be placed randomly within the boundaries of the primary color (e.g., red, green, blue) corresponding to the type of CVD indicated. The user may then be asked to move the boundary markers 308 to where they perceive are the maximum extents (e.g., boundaries) of what could be called that color. For example, for color wheel 302, the user may be asked to move (e.g., place) the boundary markers 308 at the boundaries of what they would consider blue. The area within the boundary markers 308 may be referred to as a sector and the boundary markers 308 may form a sector angle θ. As severity of CVD can vary from user to user, the sector angle θ may also vary from user to user.

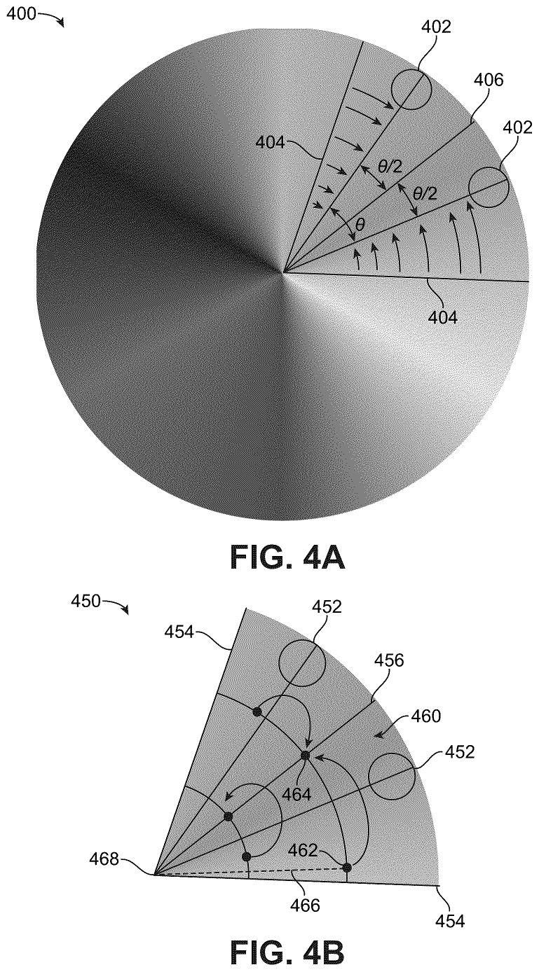

FIG. 4A is a color wheel 400 illustrating color mapping, in accordance with aspects of the present disclosure. As an example, a user may indicate that they have deuteranomaly and may place boundary markers 402 on the color wheel 400 indicating the extent what they can see as green. The boundary markers 402 may be inside of (e.g., a subset of) an actual color band 404. The actual color band 404 may denote an area within the boundaries at the maximum extent of green for a person with normal vision. A difference between where the boundary markers 402 are placed and where the actual color band 404 is may indicate a range of shades for the particular color that the user cannot perceive. A severity of an anomaly CVD may be indicated by the range of shades of a particular color a user is not able to perceive. This may be measured by the angle between the markers placed by the user. If the angle is small, the user may be able to perceive only a small range of shades of the particular color, and the anomaly CVD is severe. If the angle is large, the user may be able to perceive a larger range of the shades of the particular color, and the CVD is less severe. Based on where the boundary markers 402 are placed a center marker 406 may be determined. The center marker 406 may represent the RGB pixel values which the user would classify as the color without any confusion. The sector between the boundary markers 402 has a sector angle θ, and an angle between a boundary marker and the center marker 406 is θ/2. In some cases, intensity-based color correction may be performed to correct green colors which fall outside of the boundary markers 402, but within the actual color band 404. In some cases, the color correction may be performed, for example, by a GPU, such as GPU 104 of FIG. 1.

FIG. 4B is a green sector 450 of a color wheel illustrating color mapping, in accordance with aspects of the present disclosure. When a first pixel color 460 for a first pixel to be displayed (e.g., as indicated by an application to a GPU) is within (e.g., between) boundary markers 452, the first pixel color 460 may be displayed as is (e.g., normal). When a second pixel color 462 for a second pixel to be displayed is within an actual color band 454, but outside of the boundary markers 452 (e.g., between an edge of the actual color band 454 and a boundary marker 452) the second pixel color 462 may be remapped into the sector between the boundary markers 452. In some cases, colors to be displayed that are outside of the sector between the boundary markers 452 and within the actual color band 454 may be remapped into a middle of the sector (e.g., along a center marker 456 between the boundary markers 452) to a middle pixel color 464. In some cases, the colors that are outside of the sector between the boundary markers 452 and within the actual color band 454 may be remapped onto a nearest edge (e.g., just inside the nearest boundary marker 452) or to a point within the sector, for example, from the center marker 456 proportional to how far the color is from the nearest boundary marker 452.

In some cases, to remap pixel colors, such as the second pixel color 462, that are outside of the sector between the boundary markers 452 and within the actual color band 454 to the middle pixel color 464 by determining a radial distance 466 between the second pixel color 462 and a center 468 of the color wheel. The second pixel color 462 may then be remapped along the center marker 456 at a same radial distance 466 away from the center 468 of the color wheel to the middle pixel color 464. Of note, the color wheel may increase in color intensity as the radial distance 466 from the center 468 increases.

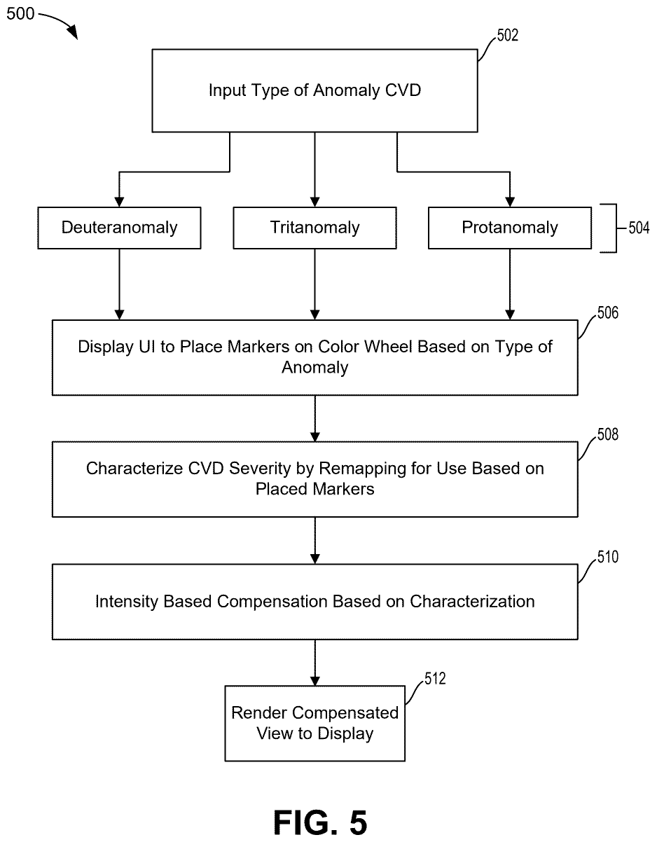

FIG. 5 is a flow diagram illustrating a process 500 for color vision improvements for anomaly CVD, in accordance with aspects of the present disclosure. In some cases, when a feature for color vision improvements for CVD on a device, such as a portable device, XR device, head-mounted device (HMD), etc., is activated, a prompt to input a type of anomaly CVD may be displayed at step 502. At step 504, the user may input a type of anomaly CVD they have (e.g., deuteranomaly, tritanomaly, or protanomaly). The user may input what type of CVD they have, for example, based on a previously taken Ishihara test and this input may be received by the device.

At step 506, a color wheel may be displayed to perform calibration. The color wheel may include boundary markers, and the user may be prompted to move the boundary markers to where they perceive are the maximum extents of a particular color visible to them based on the type of CVD that they inputted. In some cases, the boundary markers may be prepositioned around a particular color band based on the type of CVD inputted. The user may then move the boundary markers to indicate to what extent they may perceive a color. The moved boundary markers may define a sector within an actual color band for a primary color. The device may receive the moved boundary markers. At step 508, pixel color values outside of the sector and within the actual color band may be remapped to a middle of the sector to characterize a severity of the anomaly CVD. The remapping may be intensity based. For example, the color wheel may increase in color intensity as the radial distance from the center increases. The intensity-based remapping may preserve this radial distance while mapping the pixel color values outside of the sector and within the actual color band to the middle of the sector. In some cases, the GPU may be configured to perform the remapping. At step 510, intensity-based compensation may be performed based on the characterization. This intensity-based compensation may be performed by a GPU. At step 512, the compensated pixel color values may be rendered for display, such as by an HMD or other display device.

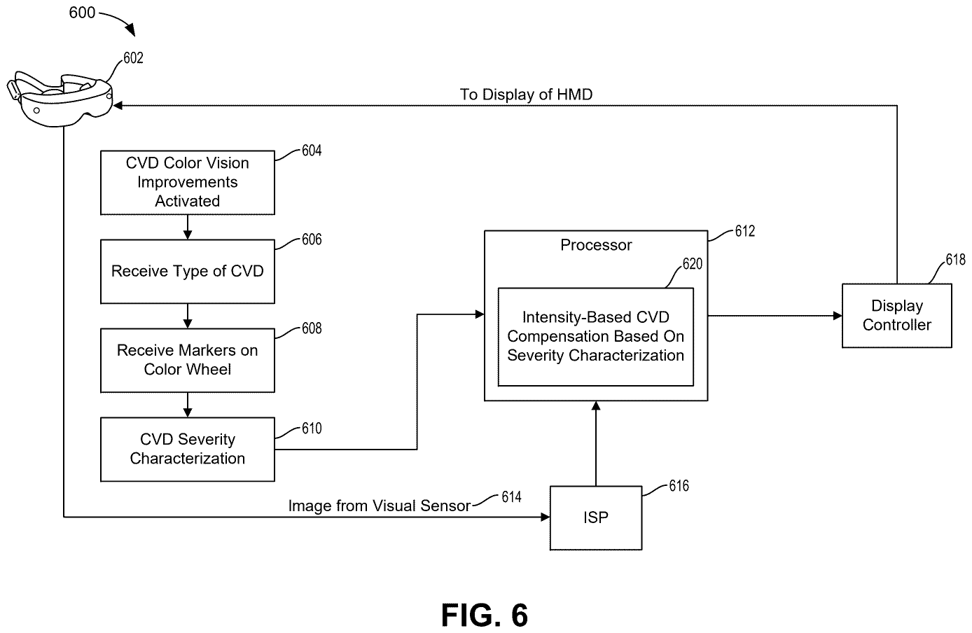

FIG. 6 is a block diagram illustrating a system for color vision improvements for CVD 600, in accordance with aspects of the present disclosure. In some cases, an HMD device 602, such as an XR device, may include the system for color vision improvements for CVD 600. As an example, the color vision improvements for CVD may be activated 604, for example, as a setting of the HMD device 602. The HMD device 602 may then receive an indication of a type of anomaly CVD 606 the user may have. The HMD device 602 may also receive markers 608 (e.g., boundary markers) indicating to what extent the user may perceive a color. The boundary markers may define a sector which may be subset of an actual color band of the color. Based on the moved boundary markers, the HMD device 602 may characterize 610 the anomaly CVD to remap pixel color values outside of the sector and within the actual color band to the sector. This remapping may be passed to a processor 612 (e.g., a GPU, CPU, ISP, etc.), which may perform the intensity-based CVD compensation 620 based on the characterization.

As an example of the remapping, the HMD device 602 may capture images 614 of a physical, real-world scene or environment using an ISP 616 (e.g., ISP 116 of FIG. 1). The ISP 616 may process the captured images 614 and prepare the images for display by the HMD device 602 to the user. The HMD device 602 may display the captured images 614 to the user to provide a view of the environment to the user. The ISP 616 may passed the processed images to the processor 612.

In some cases, the HMD device 602 (e.g., via processor 612) may add or overlay virtual content, such as video, images, graphic content, location data (e.g., global positioning system (GPS) data or other location data), sounds, any combination thereof, and/or other augmented content on the view of the environment. The processor 612 may render an image including a view of the environment and/or virtual content. The rendered image may be rendered using the intensity-based CVD compensation 620 to adjust the colors of the image to provide for color vision improvements for CVD. In some cases, the rendered images may be passed to a display controller 618 for output to a display of the HMD device 602.

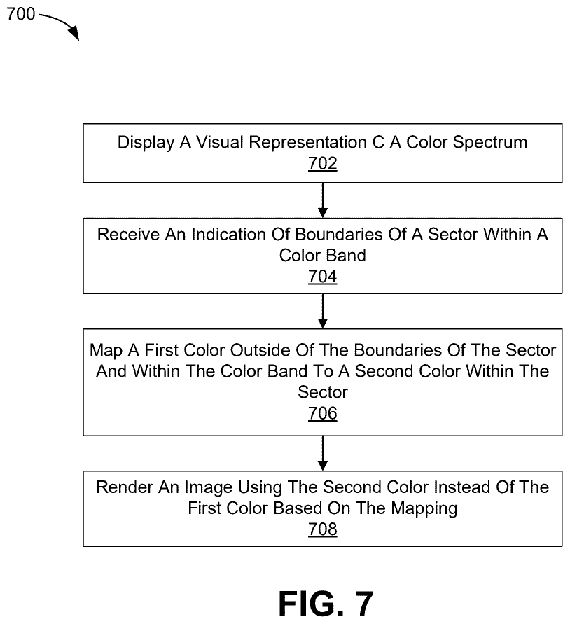

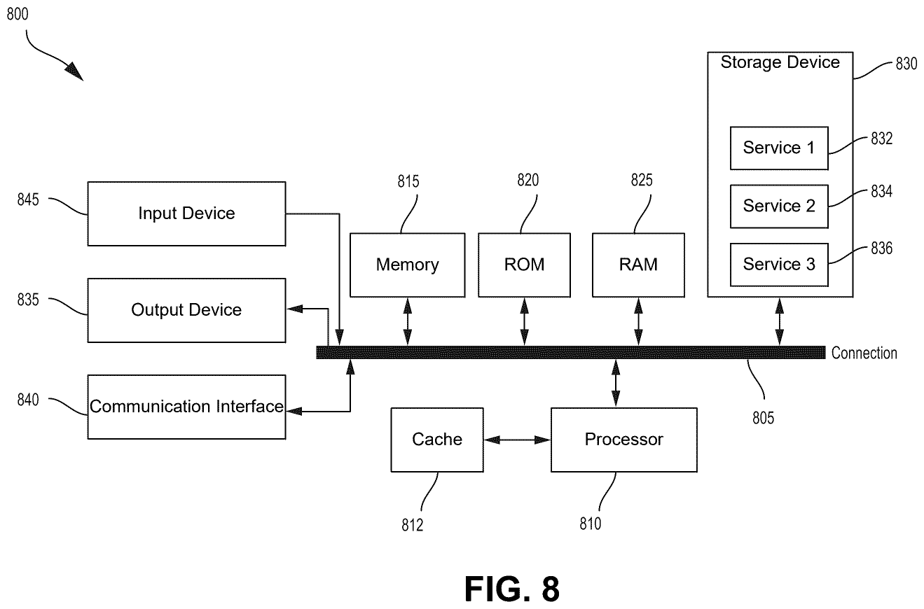

FIG. 7 is a flow diagram illustrating a process 700 for color compensation, in accordance with aspects of the present disclosure. The process 700 may be performed by a computing device (or apparatus) (e.g., SOC 100 of FIG. 1, computing device architecture 800 of FIG. 8) or a component (e.g., a chipset, codec, CPU 102, GPU 104, DSP 106, NPU 108 of FIG. 1, processor 810 of FIG. 8, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors.

At block 702, the computing device (or component thereof) may display a visual representation of a color spectrum. In some cases, the visual representation of the color spectrum comprises a color wheel (e.g., color wheel 302 of FIG. 3, color wheel 400 of FIG. 4, etc.). In some examples, the computing device (or component thereof) may receive an indication of a type of color vision deficiency (CVD) (e.g., in response to step 502 of FIG. 5) and display the visual representation of the color spectrum. In some cases, the visual representation includes a boundary marker, where the boundary marker is displayed based on the type of CVD. In some cases, the boundary markers may be prepositioned around a particular color band based on the type of CVD inputted.

At block 704, the computing device (or component thereof) may receive an indication of boundaries (e.g., actual color band 404 of FIG. 4A, actual color band 454 of FIG. 4B), of a sector within a color band. In some cases, the color band represents an extent of a color for normal vision. In some examples, the boundaries (e.g., as represented by boundary markers 308 of FIG. 3, boundary markers 402 of FIG. 4A, boundary markers 452 of FIG. 4B, etc.) of the sector represent the extent of the color for a user of the computing device. In some cases, the computing device (or component thereof) may determine a center marker (e.g., center marker 406 of FIG. 4A, center marker 456 of FIG. 4B, etc.) between the boundaries of the sector. In some examples, the computing device (or component thereof) may determine a radial distance between the first color and a center of a color wheel (e.g., center 468 of FIG. 4B). In some cases, the second color is the radial distance away from the center of the color wheel along the center marker. In some examples, the second color is along the center marker between the boundaries of the sector

At block 706, the computing device (or component thereof) may map a first color outside of the boundaries of the sector and within the color band to a second color within the sector. For example, pixel color values outside of the sector and within the actual color band may be remapped to a middle of the sector.

At block 708, the computing device (or component thereof) may render an image using the second color based on the mapping. In some cases, the computing device (or component thereof) may output the image for display. In some examples, the computing device (or component thereof) may include a head-mounted display. In some cases, the image may be displayed on the head-mounted display.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 700 and/or other processes described herein may include a processor, microprocessor, micro-computer, or other component of a device that is configured to carry out the steps of the process 700 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 700 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 700 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 illustrates an example computing device architecture 800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 800 are shown in electrical communication with each other using connection 805, such as a bus. The example computing device architecture 800 includes a processing unit (CPU or processor) 810 and computing device connection 805 that couples various computing device components including computing device memory 815, such as read only memory (ROM) 820 and random access memory (RAM) 825, to processor 810.

Computing device architecture 800 can include a cache of high-speed memory connected directly with, in close proximity to, or integrated as part of processor 810. Computing device architecture 800 can copy data from memory 815 and/or the storage device 830 to cache 812 for quick access by processor 810. In this way, the cache can provide a performance boost that avoids processor 810 delays while waiting for data. These and other modules can control or be configured to control processor 810 to perform various actions. Other computing device memory 815 may be available for use as well. Memory 815 can include multiple different types of memory with different performance characteristics. Processor 810 can include any general purpose processor and a hardware or software service, such as service 1 832, service 2 834, and service 3 836 stored in storage device 830, configured to control processor 810 as well as a special-purpose processor where software instructions are incorporated into the processor design. Processor 810 may be a self-contained system, containing multiple cores or processors, a bus, memory controller, cache, etc. A multi-core processor may be symmetric or asymmetric.

To enable user interaction with the computing device architecture 800, input device 845 can represent any number of input mechanisms, such as a microphone for speech, a touch-sensitive screen for gesture or graphical input, keyboard, mouse, motion input, speech and so forth. Output device 835 can also be one or more of a number of output mechanisms known to those of skill in the art, such as a display, projector, television, speaker device, etc. In some instances, multimodal computing devices can enable a user to provide multiple types of input to communicate with computing device architecture 800. Communication interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. Storage device 830 can include services 832, 834, 836 for controlling processor 810. Other hardware or software modules are contemplated. Storage device 830 can be connected to the computing device connection 805. In one aspect, a hardware module that performs a particular function can include the software component stored in a computer-readable medium in connection with the necessary hardware components, such as processor 810, connection 805, output device 835, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors or other suitable electronic circuits) to perform the operation, or any combination thereof.

The phrase “coupled to” refers to any component that is physically connected to another component either directly or indirectly and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for color compensation, comprising: at least one memory; and at least one processor coupled to the at least one memory, wherein the at least one processor is configured to: display a visual representation of a color spectrum; receive an indication of boundaries of a sector within a color band, wherein the color band represents an extent of a color for normal vision; map a first color outside of the boundaries of the sector and within the color band to a second color within the sector; and render an image using the second color based on the mapping.

Aspect 2. The apparatus of Aspect 1, wherein the boundaries of the sector represent the extent of the color for a user of the apparatus.

Aspect 3. The apparatus of any of Aspects 1-2, wherein the at least one processor is configured to: receive an indication of a type of color vision deficiency (CVD); and display the visual representation of the color spectrum, wherein the visual representation includes a boundary marker, and wherein the boundary marker is displayed based on the type of CVD.

Aspect 4. The apparatus of any of Aspects 1-3, wherein the visual representation of the color spectrum comprises a color wheel.

Aspect 5. The apparatus of any of Aspects 1-4, wherein the at least one processor is configured to determine a center marker between the boundaries of the sector.

Aspect 6. The apparatus of Aspect 5, wherein the second color is along the center marker between the boundaries of the sector.

Aspect 7. The apparatus of Aspect 6, wherein the at least one processor is configured to determine a radial distance between the first color and a center of a color wheel, and wherein the second color is the radial distance away from the center of the color wheel along the center marker.

Aspect 8. The apparatus of any of Aspects 1-7, wherein the at least one processor is configured to output the image for display.

Aspect 9. The apparatus of any of Aspects 1-8, wherein the apparatus comprises a head-mounted display.

Aspect 10. A method for color compensation, comprising: displaying a visual representation of a color spectrum; receiving an indication of boundaries of a sector within a color band, wherein the color band represents an extent of a color for normal vision; mapping a first color outside of the boundaries of the sector and within the color band to a second color within the sector; and rendering an image using the second color based on the mapping.

Aspect 11. The method of Aspect 10, wherein the boundaries of the sector represent the extent of the color for a user.

Aspect 12. The method of any of Aspects 10-11, further comprising: receiving an indication of a type of color vision deficiency (CVD); and displaying the visual representation of the color spectrum, wherein the visual representation includes a boundary marker, and wherein the boundary marker is displayed based on the type of CVD.

Aspect 13. The method of any of Aspects 10-12, wherein the visual representation of the color spectrum comprises a color wheel.

Aspect 14. The method of any of Aspects 10-13, further comprising determining a center marker between the boundaries of the sector.

Aspect 15. The method of Aspect 14, wherein the second color is along the center marker between the boundaries of the sector.

Aspect 16. The method of Aspect 15, further comprising determining a radial distance between the first color and a center of a color wheel, and wherein the second color is the radial distance away from the center of the color wheel along the center marker.

Aspect 17. The method of any of Aspects 10-16, further comprising outputting the image for display.

Aspect 18. The method of Aspect 17, wherein the display comprises a head-mounted display.

Aspect 19. A non-transitory computer-readable medium having stored thereon instructions that, when executed by at least one processor, cause the at least one processor to: display a visual representation of a color spectrum; receive an indication of boundaries of a sector within a color band, wherein the color band represents an extent of a color for normal vision; map a first color outside of the boundaries of the sector and within the color band to a second color within the sector; and render an image using the second color based on the mapping.

Aspect 20. The non-transitory computer-readable medium of Aspect 19, wherein the boundaries of the sector represent the extent of the color for a user.

Aspect 21. The non-transitory computer-readable medium of Aspect 19, wherein the instructions cause the at least one processor to perform operations according to any one or more of Aspects 12-18.

Aspect 22: An apparatus comprising one or more means for performing operations according to any one or more of Aspects 11-18.

What is claimed is:

1. An apparatus for color compensation, comprising:
at least one memory; and
at least one processor coupled to the at least one memory, wherein the at least one processor is configured to:
display a visual representation of a color spectrum;
receive an indication of boundaries of a sector within a color band, wherein the color band represents an extent of a color for normal vision;
map a first color outside of the boundaries of the sector and within the color band to a second color within the sector; and
render an image using the second color based on the mapping.

2. The apparatus of claim 1, wherein the boundaries of the sector represent the extent of the color for a user of the apparatus.

3. The apparatus of claim 1, wherein the at least one processor is configured to:
receive an indication of a type of color vision deficiency (CVD); and
display the visual representation of the color spectrum, wherein the visual representation includes a boundary marker, and wherein the boundary marker is displayed based on the type of CVD.

4. The apparatus of claim 1, wherein the visual representation of the color spectrum comprises a color wheel.

5. The apparatus of claim 1, wherein the at least one processor is configured to determine a center marker between the boundaries of the sector.

6. The apparatus of claim 5, wherein the second color is along the center marker between the boundaries of the sector.

7. The apparatus of claim 6, wherein the at least one processor is configured to determine a radial distance between the first color and a center of a color wheel, and wherein the second color is the radial distance away from the center of the color wheel along the center marker.

8. The apparatus of claim 1, wherein the at least one processor is configured to output the image for display.

9. The apparatus of claim 1, wherein the apparatus comprises a head-mounted display.

10. A method for color compensation, comprising:
displaying a visual representation of a color spectrum;
receiving an indication of boundaries of a sector within a color band, wherein the color band represents an extent of a color for normal vision;
mapping a first color outside of the boundaries of the sector and within the color band to a second color within the sector; and
rendering an image using the second color based on the mapping.

11. The method of claim 10, wherein the boundaries of the sector represent the extent of the color for a user.

12. The method of claim 10, further comprising:
receiving an indication of a type of color vision deficiency (CVD); and
displaying the visual representation of the color spectrum, wherein the visual representation includes a boundary marker, and wherein the boundary marker is displayed based on the type of CVD.

13. The method of claim 10, wherein the visual representation of the color spectrum comprises a color wheel.

14. The method of claim 10, further comprising determining a center marker between the boundaries of the sector.

15. The method of claim 14, wherein the second color is along the center marker between the boundaries of the sector.

16. The method of claim 15, further comprising determining a radial distance between the first color and a center of a color wheel, and wherein the second color is the radial distance away from the center of the color wheel along the center marker.

17. The method of claim 10, further comprising outputting the image for display.

18. The method of claim 17, wherein the display comprises a head-mounted display.

19. A non-transitory computer-readable medium having stored thereon instructions that, when executed by at least one processor, cause the at least one processor to:
display a visual representation of a color spectrum;
receive an indication of boundaries of a sector within a color band, wherein the color band represents an extent of a color for normal vision;
map a first color outside of the boundaries of the sector and within the color band to a second color within the sector; and
render an image using the second color based on the mapping.

20. The non-transitory computer-readable medium of claim 19, wherein the boundaries of the sector represent the extent of the color for a user.
